(19) United States
(12) Patent Application Publication
(10) Pub. No.: US 2023/0367688 A1
(43) Pub. Date: Nov. 16, 2023

(54) CLOUD-BASED MOBILITY DIGITAL TWIN FOR HUMAN, VEHICLE, AND TRAFFIC

(71) Applicant: Toyota Motor Engineering & Manufacturing North America, Inc., Plano, TX (US)

(72) Inventors: Ziran WANG, San Jose, CA (US); Rohit GUPTA, Santa Clara, CA (US); Kyungtae HAN, Palo Alto, CA (US); Prashant TIWARI, Santa Clara, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/744,452

(22) Filed: May 13, 2022

(51) Int. Cl. G06F 11/34; G06F 16/21; H04W 4/40

(52) U.S. Cl. CPC G06F 11/3447; G06F 11/3457; G06F 16/211; H04W 4/40

(57) ABSTRACT

Systems and methods are provided for effectuating and using a mobility digital twin (MDT) framework including a digital space (where digital twins reside) and a physical space (where physical objects/processes reside). The MDT framework is realized in a cloud-based system/on a cloud platform. Digital twins may represent not only vehicular entities, but human and traffic entities as data/models representative of these different physical objects/processes may be applicable to more than just a directly-related entity. Additionally, the MDT framework is able to leverage data associated with different time horizons (e.g., real-time data as well as historical data).

### TECHNICAL FIELD

The present disclosure relates generally to digital twin technologies for mobility systems, such as vehicles. More particularly, the present disclosure relates to developing and using digital twins for human, vehicular, and traffic entities or aspects with a cloud computing architecture having the ability to leverage real-time and historical data.

### DESCRIPTION OF RELATED ART

A digital twin can refer to some representation, e.g., virtual, of an object, system, or other entity. That is, a digital twin acts as a digital counterpart or model to some physical object or process. The physical object/process can be outfitted with or monitored using sensors that generate data regarding various aspects of the physical object/process, e.g., the performance of the physical object. This generated data can be relayed to a processor or other computing system which may then apply the data to the digital twin. Thereafter, the digital twin or model can be used to run simulations, study performance, generate possible improvements, and so on.

### BRIEF SUMMARY OF THE DISCLOSURE

In accordance with one embodiment, a method comprises gathering data regarding a physical object, and fetching a data schema from a cloud-based digital space comprising a digital twin corresponding to the physical object. The method further comprises conforming the data to match the data schema, and transmitting the conforming data to the cloud-based digital space. Further still, the method comprises receiving instructions controlling actuation regarding the physical object from the cloud-based digital space, the instructions having been derived from processing of the conforming data in the cloud-based digital space.

In some embodiments, the physical object comprises at least one of a vehicle, a human, and a traffic device.

In some embodiments, the gathering of the data comprises at least one of obtaining data from one or more monitoring devices associated with the physical object, and receiving data from one or more vehicle-to-anything (V2X) communications regarding the physical object.

In some embodiments, conforming the data to match the data schema comprises pre-processing one or more data fields of the data, the conforming data comprising data remaining after the pre-processing of the one or more data fields of the data to be transmitted to the cloud-based digital space.

In some embodiments, the digital twin comprises a data lake and one or more microservices, the application of which influence operation of the physical object. In some embodiments, the processing of the conforming data comprises at least one of storing the conforming data in the digital lake, modeling the physical object using the digital twin based on the conforming data, simulating the operation of the physical object using the conforming data, performing machine learning and prediction using the conforming data. In some embodiments, the data lake further comprises stored historical conforming data related to the digital twin. In some embodiments, the processing of the conforming data in the cloud-based digital space includes processing of the stored historical conforming data in addition to the stored conforming data received from the physical object.

In some embodiments, the method further comprises requesting data associated with another digital twin to be sent to the digital twin corresponding to the physical object.

In some embodiments, the method further comprises determining availability of the digital twin based prior to the transmitting of the conforming data to the cloud-based digital space. In some embodiments, the method further comprises determining availability of a digital twin corresponding to a neighboring physical object, wherein a type of the neighboring physical object is the same type as that of the physical object. In some embodiments, the method further comprises obtaining data from the data lake of the digital twin corresponding to the neighboring physical object. In some embodiments, the method further comprises processing the obtained data in conjunction with the conforming data regarding the physical object.

In some embodiments, the method further comprises determining availability of a digital twin corresponding to one or more other physical objects surrounding at least one of the physical object or the neighboring physical object. In some embodiments, the method further comprises obtaining data from the data lake of the digital twin corresponding to the one or more other physical objects surrounding at least one of the physical object or the neighboring physical object. In some embodiments, the method further comprises processing the obtained data in conjunction with the conforming data regarding the physical object.

In accordance with one embodiment, a cloud-based system effectuating an end-to-end framework, comprises a cloud-based platform hosting one or more digital twins corresponding to one or more physical objects. The system further comprises a communications layer communicatively connecting the one or more digital twins to the one or more physical objects. In some embodiments, the communications layer transmits data regarding the one or more physical objects to at least the one or more corresponding digital twins. In some embodiments, the communications layer transmits instructions that have been derived from processing of the transmitted data by the one or more digital twins to the one or more physical objects to which the one or more digital twins correspond, effectuating performance of one or more operations at or by the one or more physical objects and achieving the end-to-end framework.

In some embodiments, the one or more corresponding digital twins comprises a data lake and one or more microservices, the application of which influence operation of the one or more physical objects in achieving the end-to-end framework.

In some embodiments, the one or more physical objects comprises at least one of a vehicle, a human, and a traffic device.

In some embodiments, the processing of the transmitted data comprises modeling the one or more physical objects using the one or more corresponding digital twins, simulating operation of the one or more physical objects using the transmitted data, performing machine learning and prediction using the transmitted data.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example mobility digital twin framework in accordance with some embodiments.

FIG. 2 is a schematic representation of an example vehicle with which embodiments of the disclosed technology may be implemented.

FIG. 3A illustrates an example vehicle architecture corresponding to a vehicle aspect of the mobility digital twin framework of FIG. 1.

FIG. 3B is a flow chart illustrating example operations for uploading data to a mobility digital twin in accordance with embodiments of the disclosed technology.

FIG. 3C is a flow chart illustrating example operations of a mobility digital twin in accordance with embodiments of the disclosed technology.

FIG. 4 illustrates an example cloud architecture with which a mobility digital twin system may be implemented in accordance with embodiments of the disclosed technology.

FIG. 5 is an example computing component that may be used to implement various features of embodiments described in the present disclosure.

The figures are not exhaustive and do not limit the present disclosure to the precise form disclosed.

### DETAILED DESCRIPTION

Embodiments of the present disclosure are directed to a mobility digital twin (MDT) framework/system for use with connected vehicle technology and implemented using cloud computing. The MDT framework may comprise a plurality of functional layers that correspond to: a physical space associated with objects of interest; a digital space comprising the digital twins representative of the objects of interest; and a communications layer that enables communications between the physical and digital spaces. Moreover, such an MDT framework may be implemented as a cloud-based framework. It should be noted that while the physical space typically comprises physical entities, in some embodiments, the physical space can include processes or other aspects of an environment/scenario that are of interest and would benefit from a corresponding digital twin.

Traditional mobility system frameworks tend to rely heavily on onboard storage and computing. Thus, the MDT system can realize the following advantages over such traditional mobility system frameworks. One advantage relates to power, i.e., the MDT system enables users to rapidly adjust cloud resources to meet fluctuating/unpredictable demands, as well as provide high computing power at certain periods of peak demand. Another advantage is manageability. That is, the MDT system allows users to get their microservices up and running faster on the cloud platform, with improved manageability and less maintenance. Over-the-air (OTA) updates are also possible with the MDT framework. Yet another advance is shareability, i.e., bulk data generated by an end user can be offloaded and stored on the cloud, which can be shared, on-demand, with other end users, e.g., for those end user's microservices. Additionally still, an advantage of the MDT system is that arbitrary mobility microservices can be easily implemented on the MDT framework with minimal change to any existing cloud architecture and data structure.

It should be understood that microservices can refer generally to processes that communicate over a network to fulfill some goal or achieve some desired result using, e.g., technology-agnostic protocols, such as the Hypertext Transfer Protocol (HTTP). Microservices, as can be appreciated by the name, tend to be small in size relative to typical services which can be thought of as layers of an application. In the context of the various disclosed/contemplated embodiments, microservices can represent applications for mobility digital twins that benefit any one or more corresponding physical objects/processes. Microservices can take advantage of storage, modeling, simulation, learning, and prediction operations.

Compared to conventional digital twin frameworks/systems that are built for mobility systems, embodiments of the MDT system disclosed herein may realize the following advantages.

First, the MDT system leverages cloud computing. That is, in some embodiments, the MDT system can be implemented on a cloud architecture, e.g., based on a commercial cloud platform such as Amazon Web Services (AWS), using particular components/elements designed to operate within the MDT framework/system.

Second, embodiments of the present disclosure are not limited to vehicular digital twins. Rather, embodiments of the present disclosure can leverage human and traffic digital twins, in addition to vehicle digital twins, as well as the connections between or among the digital twins. As alluded to above, digital twins of the MDT framework may include human digital twins (representative of vehicle occupants or other human actors in the mobility space/context)), vehicle, and traffic digital twins (which can be representative of traffic flow, road conditions, weather, etc.) The data and models associated with these digital twins can also be beneficial to other elements/aspects of the MDT system, as will be discussed in greater detail below.

Third, embodiments of the present disclosure may leverage data associated with different time horizons, e.g., real-time as well as historical data. That is, besides the data that is sampled in real-time, historical data can also be retrieved from a corresponding digital twin(s)′ corresponding data lake to provide preference information of a specific physical entity. Combined with the real-time and historical data, predictions/predictions of future information can also be generated, and such data can be useful for all physical entities in an MDT framework.

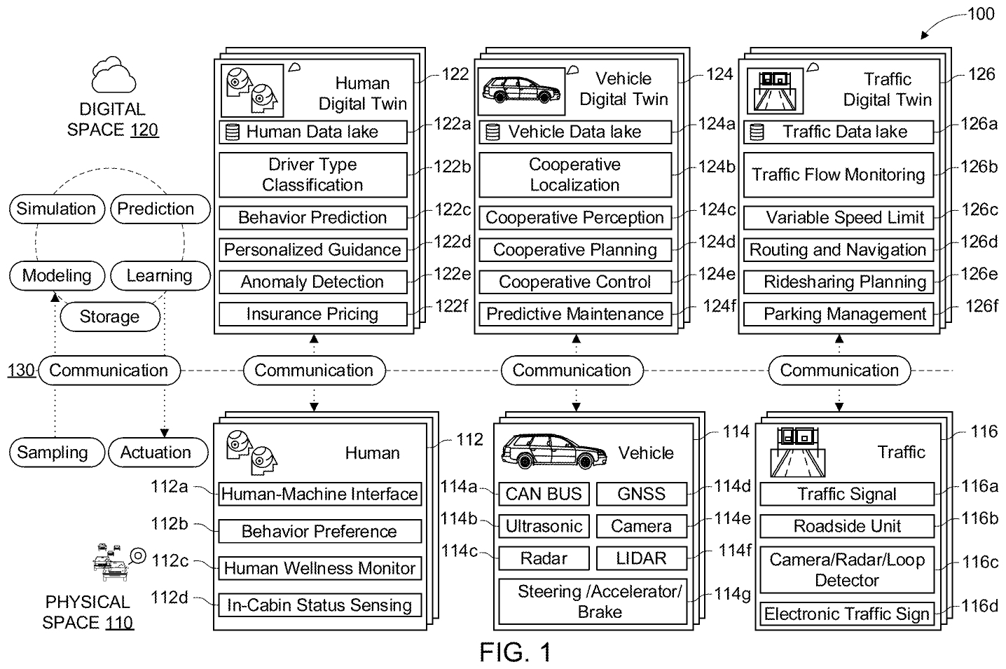

FIG. 1 illustrates an example MDT framework/system 100 in accordance with some embodiments of the present disclosure. As illustrated in FIG. 1, MDT system 100 may include a first space, e.g., physical space 110, in which human actors 112, vehicle actors 114, and traffic actors 116 logically “reside.” Sampling and actuation processes or procedures may occur in physical space 110. That is, sensors or devices capable of monitoring actors detect the dynamic status of an actor, any ongoing operations, or any event occurrences associated with the actor or impacting the actor. This sensor data or information, e.g., data samples or measurements, can be aggregated for transmission to digital space 120. Such data/information can be analyzed or processed by digital space 120 vis-à-vis the respective digital twins to which the data/information apply. Processing/analyzing the data can comprise different operations, but will ultimately produce some output(s) from a mechanism, such as a machine learning algorithm, a resulting perception, etc. that can be used to guide or instruct/command a corresponding actuation to be performed by an actor. That is, the results of the digital twin processing can be used to effectuate actuation operations by the physical entities in physical space 110, achieving an MDT system that is also an end-to-end framework, and that can be driven by physical entities in physical space 110. It should be understood that although embodiments are described in the context of vehicular mobility and thus involve human, vehicle, and traffic actors, embodiments may be adapted for use in other contexts, with other physical entities, and from which other types or kinds of digital twins may be developed and used.

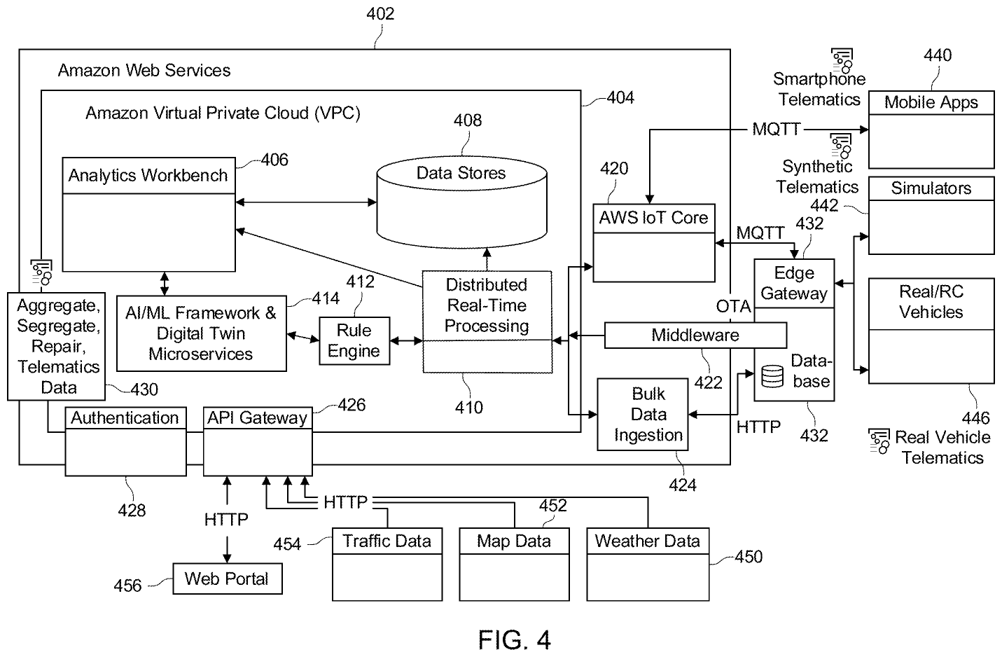

MDT system 100 may further include a communications layer 130. As can be appreciated in FIG. 1, communications layer 130 can reside between physical space 110 and digital space 120. Communications layer 130 can provide seamless connections between these two spaces. It should be understood that, seamless connections can refer to communications connections across which there are no packet losses, and only minimum time delay are experienced for communications between the digital and physical spaces, 120 and 110, respectively. Multiple aspects/elements can make up the communications layer 130, including an IoT Core 420, edge gateway 432, middleware 422, and bulk data ingestion 424 components in FIG. 4. As described above, the MDT system 100's end-to-end process may begin by sampling data in physical space 110. All or part of the sampled data may then be transmitted upstream to digital space 120 via the communication layer 130. That sampled data can progress through one or more processes in digital space 120, internally, including storage, modeling, simulation, learning, prediction, and the like. The resulting output data can be transmitted downstream to physical space 110 via the communication layer 130. That resulting output data, upon receipt, can be applied by actuators of physical space 110 to fulfill the end-to-end process.

In some embodiments, leveraging the cloud space may be realized by digital space 120 of the MDT system 110 being deployed fully or at least partially in a public, private, or hybrid cloud. A public cloud may share publicly available resources/services/microservices over, e.g., the Internet, while a private cloud is not shared and may only offer resources/services/microservices over a private data network. A hybrid cloud may share services/microservices between public and private clouds depending on the purpose of the services/microservices. Therefore, communications layer 130 provides access to the cloud for physical space 110, either via direct access or indirect access (vis-a-via network edge computing components). The MDT framework 100 does not necessarily require any specific wireless communications technology to be used by or on communication layer 130, so long as it is capable of transmitting information or data between physical space 110 and digital space 120.

Physical space 110, as illustrated in FIG. 1, may include human actor 112. Human actor 112 may be associated with sensors, such as a human wellness monitor 112c, one or more sensors/monitors generating/recording behavior preference data 112b, or in-cabin status sensors 112d, such as seat/pressure sensors. Such sensors may be used to generate or obtain current/real-time data regarding human actor 112. In accordance with some embodiments, any and all human beings (or pets/living beings) involved or related to a particular context, such as transportation/mobility can be considered. For example, in addition to vehicle drivers, vehicle passengers, pedestrians, cyclists, etc. may make up physical space 110.

The sampling process that can be performed by sensors or monitoring devices associated with the relevant physical actors of physical space 110, can be accomplished in part by human-machine interface 112a as an active manner. That is, human-machine interface 112 may comprise an interface by which a human actor 112 can input relevant information or data that may be obtained for processing/analysis by a corresponding digital twin in digital twin space 120, in this example, human digital twin 122.

Sampling may also be accomplished by in-cabin or on-vehicle status sensors 112d (e.g., camera, seat sensor, etc.), human wellness monitor 112c (e.g., smartwatch, electrocardiogram, etc.), and other perception sensors. The preferences of a human's behavior can also be set actively (e.g., a driver manually sets a preferred cruise control speed). Human preferences may also be measured passively (e.g., a pedestrian's preferred trajectory of crossing a crosswalk is recorded by a vehicle/intersection camera), where both the crosswalk and pedestrian may be considered part of physical space 110. Behavior preference sensor 112b can be representative of any one or more sensors or mechanisms with which behavioral preferences can be measured.

As noted above, actuation can be performed in physical space 110. In the context of human actor 112, where human actor 112 happens to be a vehicle driver, actuation may be accomplished by the vehicle driver actuating or operating some aspect of a vehicle based on the output from digital twin space 120, in particular, human digital twin 122. For example, human wellness monitor or sensor 112c may obtain data representative of the vehicle driver's state, such as temperature, direction of gaze, detectable markers of health wellness or distress (such as sweating). Such data may be communicated to human digital twin 122 via communications layer 130. Human digital twin 122 may analyze/process the data and output some prediction, instruction, command, etc. In this example, the instruction may be a notification sent to a display of the vehicle directing the driver of the vehicle to slow down because the driver, based on the obtained data, is determined to be in sick or in some otherwise, non-optimal state for driving. In response, the vehicle driver should actuate the brakes of the vehicle and slow down.

In the foreseeable future, the world's transportation system will likely remain a mixed autonomy traffic environment, where only part of all vehicles will be fully autonomous vehicles (with SAE level-5 automation), and the majority are still operated by human drivers (without any automation or some degree of automation). Therefore, if drivers can be provided with additional information from the digital space 120 of MDT system 100, such as an adjacent vehicle's lane-change possibility or upcoming signal timing, their actuation will be more accurate, and in turn benefit other entities in the transportation system.

Vehicles can be thought of as comprising the core or base of the MDT framework/system 100. Indeed, vehicles can act as the “host” of drivers and passengers, and are also a fundamental component of traffic. As can be seen in FIG. 1, all sensors or other components in physical space 110—not only those associated with vehicle actor 114 itself, but also those associated with human actor 112 and traffic actor 116 and the Traffic block, are directed to vehicle-related activities. However, and again, the context and particular actors/sensors/mechanisms illustrated or described herein are non-limiting examples.

As illustrated in FIG. 1, vehicle actor 114 may be associated with a localization component, such as a Global Navigation Satellite System (GNSS) sensor/receiver 114d, perception sensors (which can include, as illustrated, ultrasonic sensor 114ab, camera 114e, radar 114c, and Light Detection and Ranging (LIDAR) sensors 1141), and a vehicle's internal communication mechanism, e.g., a Controller Area Network (CAN) bus. Such components can be involved in the sampling operations performed by vehicle actor 114. Related data, such as positions, speeds, and accelerations of the vehicle and its surrounding vehicles can be sampled with these or other appropriate sensors or other physical components. The captured or sampled data can then be propagated to digital space 120 through communications layer 130.

The actuation functionality of vehicle actor 114, in some embodiments, can be effectuated by one or more vehicle systems or components used to generate movement or accomplish some other operation. For example, vehicle actor 114 may be associated with or comprise vehicle motive systems 114g, e.g., a vehicle steering system, an accelerator, and brakes. These physical components are able to actuate any lateral or longitudinal control command received from the digital space 120, and therefore allow a vehicle to achieve its desired motion or position or action.

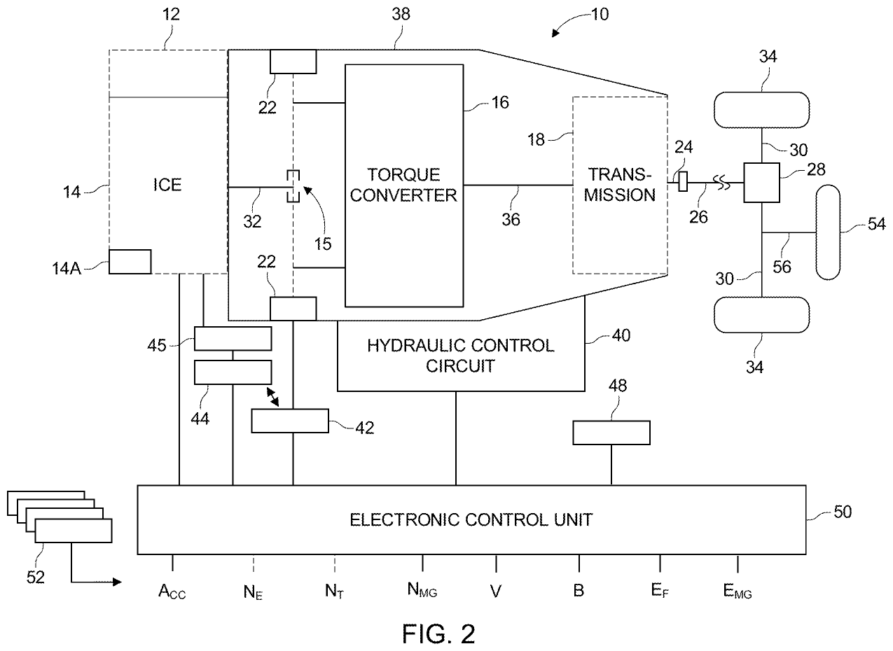

The systems and methods disclosed herein may be implemented with any of a number of different vehicles and vehicle types. For example, the systems and methods disclosed herein may be used with automobiles, trucks, motorcycles, recreational vehicles, boats, and other like on- or off-road vehicles. In addition, the principals disclosed herein may also extend to other vehicle types as well. An example hybrid electric vehicle (HEV) in which embodiments of the disclosed technology may be implemented is illustrated in FIG. 2. Although the example described with reference to FIG. 2 is a hybrid type of vehicle, the systems and methods for predictive perception assessment can be implemented in other types of vehicle including gasoline- or diesel-powered vehicles, fuel-cell vehicles, electric vehicles, or other vehicles.

FIG. 2 illustrates a drive system of a vehicle 10 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30. Direction of travel of the vehicle (e.g., a moving direction or heading) may be based on the angle of the one or more wheels 34, which can be controlled by steering wheel 54. Rotation of steering wheel 54 may be transmitted to axles 30 by steering column 56 coupled to the axles 30 so to convert rotational motion of the steering wheel into translational motion of the axles (e.g., a rack and pinion steering or the like). Translational motion of the axles 30 is transferred to the wheels to change the wheel angle in accordance with the rotation of the steering wheel 54.

As an HEV, vehicle 10 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 10 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit (ECU) 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 10 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 2, electronic control unit 50 receives information from a plurality of sensors included in vehicle 102. For example, electronic control unit 50 may receive signals that indicate vehicle in-vehicle operating conditions or characteristics, or signals that can be used to derive vehicle operating conditions or characteristics. These may include, but are not limited, to accelerator operation amount (A_{CC}), a revolution speed (N_{E}) of internal combustion engine 14 (engine RPM), a rotational speed of the motor 22 (motor rotational speed), and vehicle speed (NV). These may also include torque converter 16 output (N_{T}) (e.g., output amps indicative of motor output), brake operation amount/pressure (B), battery SOC (i.e., the charged amount for battery 44 detected by a system on chip (SOC) sensor). Sensors 52 can also detect a gas pedal position, brake pedal position, and steering wheel position (e.g., an angle from a neutral steering wheel position). Accordingly, vehicle 10 can include a plurality of sensors 52 that can be used to detect various conditions internal or external to the vehicle and provide sensed conditions to engine control unit 50 (which, again, may be implemented as one or a plurality of individual control circuits). In various embodiments, sensors 52 may be included to detect one or more conditions directly or indirectly such as, for example, fuel efficiency (E_{F}), motor efficiency (E_{MG}), hybrid (internal combustion engine 14+MG 12) efficiency, acceleration (A_{CC}), etc. Sensors 52 may also be included to detect one or more conductions, such as brake pedal actuation and position, accelerator pedal actuation and position, and steering wheel angle, to name a few.

Additionally, one or more sensors 52 can be configured to detect, and/or sense position and orientation changes of the vehicle 10, such as, for example, based on inertial acceleration, trajectory, and so on. In one or more arrangements, electronic control unit 50 can obtain signals from vehicle sensor(s) including accelerometers, one or more gyroscopes, an inertial measurement unit (IMU), a dead-reckoning system, a global navigation satellite system (GNSS), a global positioning system (GPS), a navigation system, and/or other suitable sensors. In one or more arrangements, electronic control unit 50 receives signals from a speedometer to determine a current speed of the vehicle 10.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output. Additionally, as alluded to above, the one or more sensors 52 can be configured to detect, and/or sense in real-time. As used herein, the term “real-time” means a level of processing responsiveness that a user or system senses as sufficiently immediate for a particular process or determination to be made, or that enables the processor to keep up with some external process.

Sensors 52 may be included to detect not only vehicle conditions and dynamics but also to detect external conditions as well, for example, contextual information of the surrounding environmental conditions. Sensors that might be used to detect external conditions can include, for example, sonar, radar, lidar or other vehicle proximity sensors, and cameras or other image sensors. Such sensors can be used to detect, for example, traffic signs indicating a current speed limit, road curvature, road type, obstacles (e.g., other surrounding vehicles and objects), space gaps with obstacles, weather, time of day, road type, road surface conditions, and a traffic conditions, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

Accordingly, the one or more sensors 52 can be configured to acquire, and/or sense external environmental conditions. For example, environment sensors can be configured to detect, quantify and/or sense objects in at least a portion of the external environment of the vehicle 10 and/or information/data about such objects. Such objects can be stationary objects and/or dynamic objects. Further, the sensors 52 can be configured to detect, measure, quantify and/or sense other things in the external environment of the vehicle 10, such as, for example, lane markers, signs, traffic lights, traffic signs, lane lines, crosswalks, curbs proximate the vehicle 10, off-road objects, etc.

Sensors 52 may be included to detect not only external conditions but also to detect internal conditions as well, for example, contextual information of the environmental conditions inside the cabin of the vehicle, for example, in-cabin conditions. Sensors that might be used to detect in-cabin conditions can include, for example, sonar, radar, lidar or other proximity sensors, and cameras or other image sensors. Such sensors can be used to detect, for example, occupants of the vehicle; head status (e.g., head position or facing direction) of occupants, such as a driver; eye status (e.g., open/closed status, eye position, and eye movement) of occupants, such as the driver; and so on.

Accordingly, the one or more sensors 52 can be configured to acquire, and/or sense in-cabin conditions. For example, in-cabin sensors can be configured to detect, quantify and/or sense objects and status in at least a portion of the cabin of the vehicle 10 and/or information/data about such objects. Such objects can be stationary objects and/or dynamic objects.

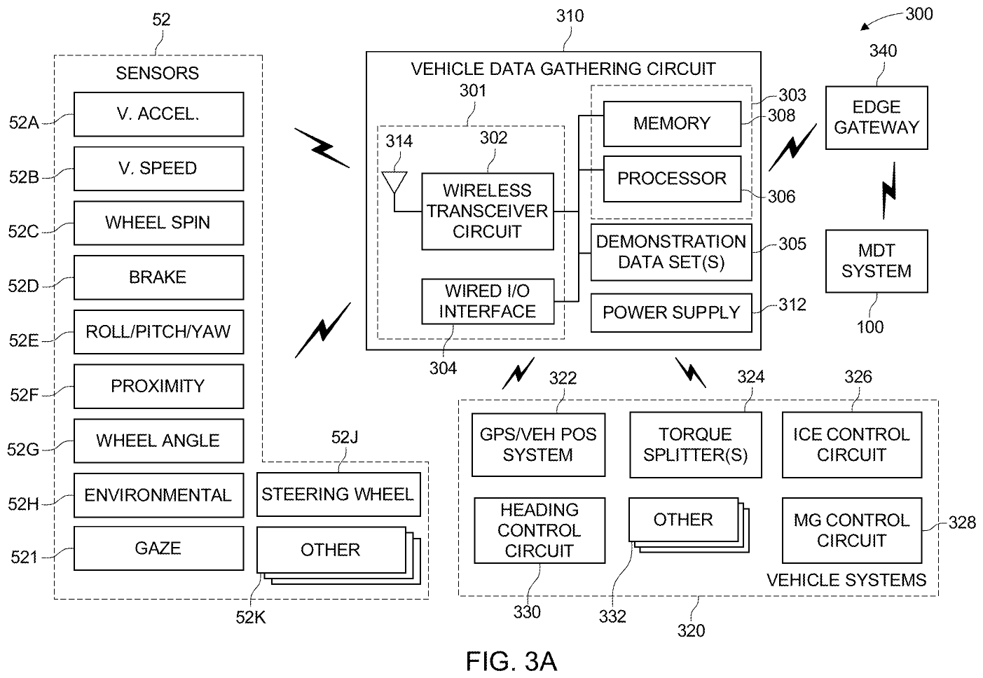

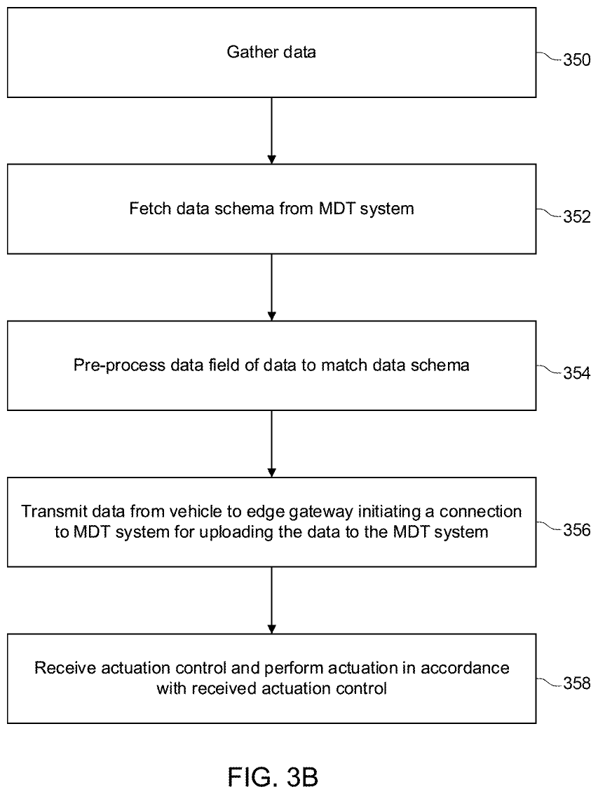

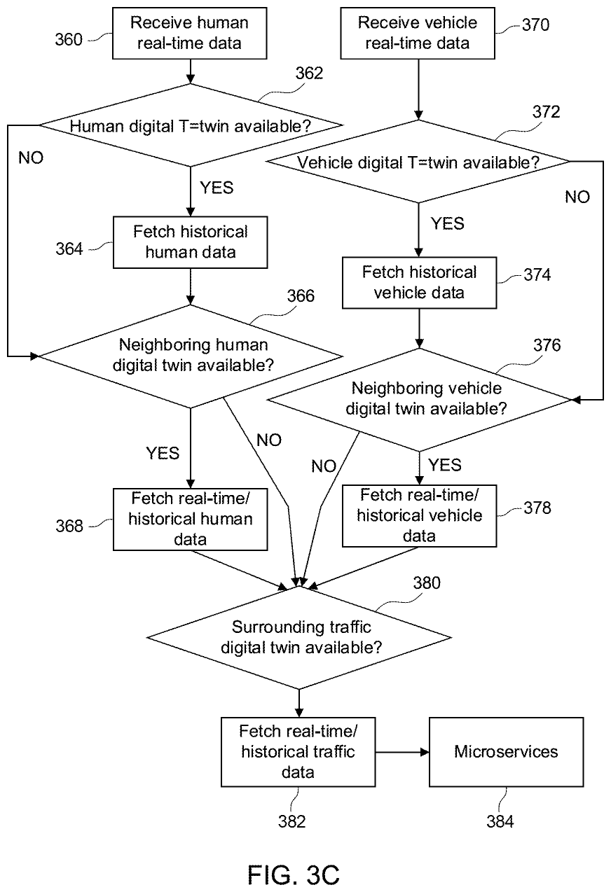

The detected data discussed herein may be included as vehicle-related data. For example, sensors 52 may acquire internal vehicle information, external environment data, in-vehicle operating conditions and dynamics, or any other information described herein. In some examples, sensors 52 may generate the vehicle-related data and/or other vehicle systems illustrated in FIG. 3 may receive the data from sensors 52 to generate the vehicle-related data.

Returning to FIG. 1, it should be noted that existing intelligent vehicle platforms and applications, such as Advanced Driver Assistance Systems (ADAS) or Autonomous Driving Systems (ADS), only focus on their performances on an ego vehicle without considering interactions with the larger-scale traffic network. In contrast, yet another actor in physical space 110 comprises traffic actor 116. Traffic, although not typically modeled as a digital twin in conventional systems and methodologies, obviously can impact vehicle operation, human interactions, and other vehicles/traffic. Thus, MDT system 100, which includes traffic actor 116, can not only benefit connected vehicles and their occupants, but also the traffic network as a whole.

Traffic actor 116 in physical space 110 can include or be associated with various traffic infrastructures, such as traffic signals 116a, roadside units 116b, camera/radar/loop detectors 116c, and electronic traffic signs 116d. These physical components are able to either generate data (e.g., signal phase and timing) by themselves, or measure data (e.g., traffic count and traffic flow) generated by other traffic entities. Such data is sampled and sent to the digital space 120 through communication layer 130.

On the other hand, guidance or adjustment received from the digital space 120, i.e., actuation, can also be accomplished by traffic actor 116 to improve the safety and efficiency of a traffic network (whether local to a current location of a vehicle or the larger traffic network). For example, the signal phase and timing of traffic signals 116a can be adjusted to better serve different traffic flows under different situations. Guidance or warning information can be broadcast to connected vehicles via roadside units 116b, and to all traffic entities via electronic traffic signs 116d.

Human digital twins, an example of which is human digital twin 122, are digital replicas of real humans in the physical space, i.e., physical space 110. This building block in digital space 120 has a human data lake 122a that stores all data sampled from human actor 112 in physical space 120, where different humans may have their personal databases differentiated from others. For example, each human actor/human digital twin may be associated with a unique identifier or uniquely correlated with one another. With real-time data sampling and historical data storage, human digital twin 122 is able to classify human actors, e.g., vehicle drivers, into specific driver types by machine learning algorithms like k-nearest neighbors (KNN), as one example (those of ordinary skill in the art would understand/know other appropriate algorithms/mechanism), and to provide guidance in a customized or personalized manner.

As alluded to above, data regarding any one or more actors can be leveraged/used by any one or more digital twins. In other words, communications layer 130 need not only communicate data/information between a particular actor and its corresponding digital twin, but may communicate data/information between any actor(s) and any digital twin(s). For example, taking advantage of the data coming from vehicle actor, human digital twin 122 can also predict future behaviors of drivers (e.g., lane-change intention) and detect any anomalies (actions or operations that are not considered acceptable, e.g., swerving left/right in a lane of travel, accelerating and braking aggressively, cutting in/out of traffic, etc. It should be noted that different contexts, actors, etc. may dictate what constitutes normal/abnormal or acceptable/unacceptable actions/operations. The results of the aforementioned microservices (driver type classification 122b, behavior prediction 122c, personalized guidance 122d, anomaly detection 122e) can be applied to third parties such as insurance companies, where they can further build a microservice to set the insurance pricing for different drivers based on their driving behaviors (i.e., insurance pricing 122f).

Vehicle digital twins, an example of which is vehicle digital twin 124, are the digital replicas of real vehicles in the physical space, e.g., physical space 120. Once the sampled data is received from a connected vehicle in the physical space, e.g., vehicle actor 114, it can be saved in this particular vehicle's data lake, e.g., vehicle data lake 124a with a unique identifier, e.g., a unique identification number. The data associated with vehicle digital twin 124 about vehicle actor (e.g., an ego vehicle) 114, for example, position, speed, and acceleration, as well as its surrounding environment (perceived by perception sensors not shown) can also be shared with human digital twin 122, traffic digital twin 124, or other connected vehicles' vehicle digital twins for various microservices.

With massive data storage and data sharing in the digital space 120, multiple vehicle-related microservices can be enabled, such as microservices requiring cooperation among multiple connected vehicles, including but not limited to, e.g., cooperative localization, cooperative perception, cooperative planning, and cooperative control. Additionally, microservices that need time-series data can also benefit from this MDT framework 100, where one typical example is predictive maintenance. That is, based on modeling and simulation of the time-series vehicle data that is sampled from vehicle actor 114 in physical space 120 and stored “in” the vehicle digital twin 124, i.e., stored in/as part of vehicle data lake 124a, a learning process can be conducted in the digital space 120 and predictions can be made regarding potential failures of vehicle components at a future time. Such prediction results can be used by the vehicle owner or manufacturer to schedule onsite maintenance before the components break down. It should be understood that each of human data lake 122a, vehicle data lake 124a, and traffic data lake 126a can refer to any appropriate data/storage repository or repositories that hold the data communicated to digital space 120 from physical space 110 by communications layer 130. Typically, the data stored in the respective data lakes will be raw data, e.g., data in its native form, prior to being analyzed or otherwise processed.

FIG. 3A an example system architecture of a vehicle 300 which can be an embodiment of vehicle actor 112/vehicle 10, and will be described in conjunction with FIG. 3B, a flow chart illustrating example operations for communicating data from an actor, e.g., vehicle 114, in the physical space 110 to a digital mobility twin, e.g., vehicle digital twin 124. FIG. 3A will also be described in conjunction with FIG. 3C, a flow chart illustrating, from a mobility digital twin perspective, how data from a physical actor in the physical space 110 is obtained by the mobility digital twin in digital space 120. In this example, vehicle 300 comprises vehicle data gathering circuit 310, a plurality of sensors 52, and one or more vehicle systems 320. Sensors 52 and vehicle systems 320 can communicate with vehicle data gathering circuit 310 via a wired or wireless communication interface. Although sensors 52 and vehicle systems 320 are depicted as communicating with vehicle data gathering circuit 310, they can also communicate with each other as well and with other vehicle systems. Vehicle data gathering circuit 310 can be implemented as an ECU or as part of an ECU such as, for example ECU 50. In other embodiments, vehicle data gathering circuit 310 can be implemented independently of an ECU.

Vehicle data gathering circuit 310, in this example, includes a communication circuit 301, a decision circuit 303 (including a processor 306 and memory 308 in this example) and a power supply 312. Components of vehicle data gathering circuit 310 are illustrated as communicating with each other via a data bus, although other communication in interfaces can be included.

Processor 306 can include a GPU, CPU, microprocessor, or any other suitable processing system. Memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory and may be configured to store data and other information as well as operational instructions that may be used by the processor 306 to control vehicle data gathering circuit 310.

Although the example of FIG. 3A is illustrated using processor and memory circuitry, as described below with reference to circuits disclosed herein, decision circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up vehicle data gathering circuit 310.

Communication circuit 301 may be either or both a wireless transceiver circuit 302 with an associated antenna 314 and a wired I/O interface 304 with an associated hardwired data port (not illustrated). Communication circuit 301 can provide for V2X, V2I, and/or V2V communications capabilities, allowing vehicle data gathering circuit 310 to communicate with roadside equipment or infrastructure (e.g., traffic signal 116a or roadside unit 116b (FIG. 1), cloud devices (e.g., cloud servers in the digital space 120) vis-à-vis communications layer 130 (FIG. 1), or other vehicles.

As this example illustrates, communications with vehicle data gathering circuit 310 can include either or both wired and wireless communications circuits 301. Wireless transceiver circuit 302 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by vehicle data gathering circuit 310 to/from other entities such as sensors 52 and vehicle systems 320.

Wired I/O interface 304 can include a transmitter and a receiver (not shown) for hardwired communications with other devices. For example, wired I/O interface 304 can provide a hardwired interface to other components, including sensors 52 and vehicle systems 320. Wired I/O interface 304 can communicate with other devices using Ethernet or any of a number of other wired communication protocols whether standardized, proprietary, open, point-to-point, networked or otherwise.

Power supply 310 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 52 can include, for example, those described above with reference to the example of FIG. 1 or FIG. 2. Sensors 52 can include additional sensors that may or not otherwise be included on a standard vehicle. In the illustrated example, sensors 52 include operational sensors, for example, sensors to detect engine operating characteristics (e.g., fuel flow, RPM, oxygen flow, engine oil temperature, and so on); sensors to detect vehicle operating characteristics (e.g., steering input sensors such as a steering wheel encoder, brake sensors to detect the amount of braking applied, sensors to detect the amount of throttle/accelerator input, and so on) and sensor to detect vehicle dynamics (e.g., accelerometers to detect vehicle roll, pitch and yaw, accelerometers to detect wheel displacement, and so on).

For example, as shown in FIG. 3A, sensors 52 may include operational sensors, such as but not limited to, vehicle accelerator sensors 52A to detect accelerator pedal actuation and/or pedal position (e.g., an amount of throttle input), vehicle speed sensors 52B to detect vehicle speed, wheelspin sensors 52C (e.g., one for each wheel), brake sensor 52D to detect brake pedal actuation and/or to pedal position (e.g., an amount of braking input), accelerometers such as a 3-axis accelerometer 52E to detect roll, pitch, and yaw of the vehicle (e.g., to detect vehicle heading), wheel angle sensor 52G to detect an angle of the wheel 34; and steering wheel sensor 52J to detect an position (e.g., angle) of the steering wheel 54.

Sensors 52 may also include sensors to detect external characteristics of the vehicle surroundings and internal characteristics of vehicle 300. External environmental condition sensors may be included to detect distance and distance changes to external objects (e.g., distance to other vehicles, ground clearance, distance to external objects, and so on); temperature, pressure and humidity sensors to detect weather conditions; and other sensors to detect other external conditions. Image sensors can be used to detect, for example, the presence of lanes (e.g., by detecting lines in the road, curbing, medians, etc.), traffic signs, road curvature, obstacles, and so on. For example, sensors 52 include external condition sensors, such as but not limited to, proximity sensors 52E to detect and recognize objects and features in surrounding proximate to the vehicle and environmental sensors 52H to detect external environmental conditions, surrounding objects, and so on. The external environmental condition sensor may include or otherwise communicably coupled to (e.g., via wired or wireless communications via communication circuit 301) to image capturing and/or range detecting devices, such as but not limited to, cameras; radar, lidar, sonar, infrared sensors, to name a few (e.g., camera 114e, LIDAR 114f, radar 114c, etc. of FIG. 1).

Sensors 52 may also include sensors to detect internal conditions of the vehicle, for example, in the vehicle cabin (e.g., in-cabin). Internal environmental condition sensors may be included to detect objects and occupants present in the cabin (e.g., driver, occupants in front and/or rear seats, etc.); movement of occupants and extremities thereof; and other sensors to detect other internal conditions. For example, as shown in FIG. 3A, sensors 52 include internal condition sensors, such as but not limited to, gaze sensors 521 to detect status (e.g., open or closed in the case of eyes) and positions of an occupant's head and eyes (e.g., for head and eye tracking and gaze direction estimation). The internal condition sensors may include or otherwise communicably coupled to (e.g., via wired or wireless communications via communication circuit 301) to image capturing and/or range detecting devices, such as but not limited to, cameras; radar, lidar, sonar, infrared sensors, to name a few.

While the preceding described various example sensors. Embodiments herein are not limited to only those sensors described, additional/other sensors 52K can also be included as may be appropriate for a given implementation of vehicle 300. Furthermore, vehicle systems 320 may also provide vehicle-related data relevant to vehicle operation, characteristics, and dynamics to the vehicle data gathering circuit 310. For example, operation states of vehicle 300 (e.g., motor, engine, wheel angle, etc.) used by vehicle systems 320 may be supplied as vehicle-related data and/or used in conjunction with data collected by sensors 52.

Vehicle systems 320 can include any of a number of different vehicle components or subsystems used to control or monitor various aspects of the vehicle and its performance. In this example, the vehicle systems 320 include a global positioning system (GPS) or other vehicle positioning system 322; torque splitters 324 that can control distribution of power among the vehicle wheels such as, for example, by controlling front/rear and left/right torque split; engine control circuits 326 to control the operation of engine (e.g. Internal combustion engine 14); motor control circuits 328 to control operation of motor/generator (e.g., motor 32); heading control circuits 330 to control the direction of travel (e.g., the angle of wheels 34 and/or steering wheel 54); and other vehicle systems 332 (e.g., Advanced Driver-Assistance Systems (ADAS), such as forward/rear collision detection and warning systems, pedestrian detection systems, and the like).

As alluded to above, vehicle systems 320 may also provide vehicle-related data relevant to vehicle operation, characteristics, and dynamics to the vehicle data gathering circuit 310. For example, vehicle position system 322 may supply positional information; heading control circuit 330 may supply heading direction information; an ADAS system may supply hazard (e.g., obstacles, pedestrians, vehicles, etc.) detection; and the like. In some examples, data from the vehicle systems 320 may be used to derive vehicle-related data, for example, position and heading from vehicle systems 320 may be used to determine trajectory data.

Referring now to FIG. 3B, data (e.g., samples and measurements regarding operating conditions of a vehicle, e.g., vehicle actor 114, conditions of a driver of the vehicle, e.g., human actor 112, etc.) are gathered at operation 350. As discussed above, actors in the physical space 110 may comprise or be associated with sensors, monitoring devices and the like to obtain relevant data that can be used by or for a digital twin in digital space 120. For example, vehicle data gathering circuit 310, by way of communication circuit 301, can receive data from various vehicle sensors 52 and/or vehicle systems 320 (as well as V2I and V2V communications) regarding vehicle operating information (e.g., data), external environmental information, and/or in-cabin information (collectively referred to as vehicle-related data). Upon receipt of the aforementioned data and/or information, the data/information may be stored in memory 308, e.g., in a cache or buffer portion of memory 308. Decision circuit 303 may access memory 308 to analyze the received data/information to determine what data/information should be retained and/or transmitted to cloud devices, e.g., to digital space 120. In some embodiments, all gathered data can be transmitted to the digital space 120 and decision circuit 303 need not filter the gathered data to determine what is transmitted to the digital space 120 and what is not transmitted.

For example, decision circuit 303 receives vehicle-related data from sensors 52 and/or vehicle systems 302 and stores the received information as demonstration data set(s) 305 for transmission to digital space 120, in this example, to data lake 122a of vehicle digital twin 122. The sensors 52 may be sampled at any desired sampling rate while the vehicle is manually operated by a driver, for example, sensors 52 collect data every 1/100 of a second and are provided to the vehicle data gathering circuit 310 at the same rate. Each instance of sampling of vehicle-related data may be grouped together as a demonstration, for example, based on a timestamp at which point the sampling of the vehicle-related data occurred. Any sampling rate may be used as desired, as long as the rate is high enough to capture the dynamics of the target object.

At operation 352, the relevant data schema from one or more digital twins intended to receive the data can be obtained. It should be noted that the data schema associated with different digital twins can vary. Data schemas can be different even between different ones of the same type(s) of twins. In some embodiments, digital space 120 determines where to send data received from physical space 110 (e.g., based on the aforementioned unique identifier(s)/correspondence between digital twin/physical actor or operation. This is, sending all gathered data to all digital twins can, in some scenarios/environments, require too much communication bandwidth and computing power (although doing so is still possible if so desired). A certain microservice of a digital twin can, for example, request the data from other digital twins based on that certain microservice's requirement(s), achieving the same result, i.e., any digital twin having access to any data of any physical actor/operation.

Upon receipt of the relevant data schema(s), decision circuit 303 may conform the data to match the data schema. For example, decision circuit 303 may pre-process a data field of the gathered data to match the fetched data schema at operation 354. For example, consider a scenario, where a human digital twin is being constructed/built to learn a specific driver's car-following behavior. Raw data collected from a vehicle operated by the driver, CAN bus, and radar sensors can be processed in accordance with the following steps: (1) calculate a time gap based on ego vehicle speed (from CAN bus), and a distance gap regarding a preceding vehicle (from radar measurements); (2) Filter out a segment(s) of data when such data is not generated during a car-following event, judging from the distance gap value (when larger than 100 m) and radar detection flag (when no object is detected). In this way, only relevant data in accordance with the requisite data schema need be sent to the human digital twin, that relevant data being car-following event data.

At operation 356, the vehicle may transmit the gathered data (as pre-processed according to the fetched data schema(s)), to digital space 120. In some embodiments, as illustrated in FIG. 3A, the vehicle data gathering circuit 310 may first transmit the data to an edge gateway 340 via communication circuit 301. The edge gateway 340 in turn may initiate a connection with the digital space 120 via communications layer 130. The gathered data can be tagged with or otherwise linked with an identifier associated with the vehicle actor 114/vehicle digital 124. For example, communications layer 130 may comprise the necessary software/hardware functionality/componentry to route data from a physical actor to an appropriate digital twin. As will be described below, AI or other appropriate techniques can be applied to the demonstration data set(s) to learn a digital twin model for the vehicle, i.e., vehicle digital twin 124, associated with the demonstration data set(s). Subsequent demonstration data (e.g., current vehicle-related data) may also be input into the digital twin model as observations. The subsequent demonstration data may be supplied in real-time as the most recent vehicle-related data.

As noted above, MDT system 100 can operate as an end-to-end framework, where data obtained in the physical space 110 can be communicated to and used by the digital space 120 by mobility digital twins to generate actuation controls that can be performed by the relevant actors in the physical space 110. Thus, at operation 358, actuation control(s) may be received and one or more actuations can be performed in accordance with the received actuation control. For example, in various embodiments, communication circuit 301 can be used to send actuation control signals (received from one or more mobility digital twins) to various vehicle systems 320 as part of controlling the operation of the vehicle, for example, based on application of the mobility digital twin on a current observation. For example, communication circuit 301 can be used to send vehicle operation inputs as signals to, for example, one or more of: motor controllers 326 to, for example, control motor torque, motor speed of the various motors in the system to control acceleration and/or declaration of the vehicle according to some control policy; ICE control circuit 326 to, for example, control power to engine 14 to, for example, to control acceleration and/or declaration of the vehicle according to the control policy; and/or brake pedal actuation, for example, to decelerate the vehicle according to the control policy.

The decision regarding what action to take via the various vehicle systems 320 can be made based on the information detected by sensors 52. For example, proximity sensor 52F may detect a lead vehicle at a distance from the vehicle 300. Decision circuit 303 may determine, based on application of the vehicle digital twin 124 that that the following distance should be increased so as to align with historical vehicle-following behavior of the driver (i.e., human actor 112). The communication circuit 301 may communicate control signals from the decision circuit 308 to control deceleration of the vehicle (e.g., reduce power output from engine 14, reduce motor speed of motor 32, and/or brake pedal actuation) to achieve a following distance according to the control policy. Similarly, the following distance may be reduced, lane-keeping may be maintained, navigation/heading control may be determined according to the digital twin model to mimic driving styles and behaviors of the driver.

Returning to FIG. 3A, traffic digital twins, an example of which is traffic digital twin 126, are the digital replicas of traffic actors, such as infrastructures, which receive data from such infrastructure in the physical space 110. Such sampled data, like signal phase and timing, traffic count, and traffic flow, can be stored in the traffic data lake 124a for future reference. It can also be used for multiple traffic microservices in real time, such as monitoring the traffic condition, variable speed limit, routing and navigation, ridesharing planning, and parking management.

Similar to human digital twin 122 and vehicle digital twin 124, traffic digital twin 126 can be enhanced by the communication between the various digital twins. For example, routing and navigation microservice 126d can be carried out solely by the real-time traffic flow data sampled from camera/radar/loop detectors in the real world (physical space 110). However, they can be further enhanced if behavior preferences are set by human actor 112 and predictions are made by human digital twin 122 (e.g., a driver/passenger always goes to grocery stores when his/her commute route is highly congested). Additionally, if vehicle actor 112 detects that its fuel/battery level is low and sends that to vehicle digital twin 122, it can also assist the routing and navigation microservice 126d to find a gas/charging station near a user-preferred grocery store along the original route.

Referring now to FIG. 3C, at operations 360 and 370, real-time or current data associated with a human actor 112 and vehicle actor 114, respectively, may be received via communications layer 130 at digital space 120. For example, vehicle data gathering circuit 310 may receive sensor data from one or more of sensors 52 monitoring aspects of human actor 112, in this case, a driver of vehicle 100/300, and data from one or more sensors 52 monitoring the vehicle 100/300 itself. At operations 362 and 372, a determination is made regarding whether or not a corresponding mobility digital twin is available, respectively. In this context, checking availability can refer to determining whether or not a digital twin exists in digital space 120 to receive data from its corresponding physical actor/operation. For example, this check/determination process can be conducted by querying the license plate number of a vehicle (for human digital twin) and a model of the vehicle (for vehicle digital twin) in the cloud. If there are no record of these digital twins in the cloud, then it either means this particular driver/vehicle has no digital twin, or he/she/it does not want to disclose his/her/its digital twin to other parties. For physical/digital paring/synchronization, drivers can be associated to their vehicles license plate numbers (e.g., one embodiment of the aforementioned unique identifiers), while vehicles can be associated to their makes, models and years of manufacture.

If a corresponding mobility digital twin is available, that available mobility digital twin may, at operations 364 and 374, fetch historical data/information regarding the human actor and the vehicle itself from their respective data lakes, human data lake 122a and vehicle data lake 124a. For example, consider a scenario where again, the desire is to model the car-following behavior of a driver to design a personalized adaptive cruise control system for the vehicle he/she is driving. The model to be developed not only leverages the real-time data the driver is generating, but also the historical data generated by the driver from his/her past trips, so it can better learn the driver's behavior. If only based on the real-time data, the amount of data/samples might not be enough to accurately represent or be indicative of a driver's behavior(s), and the resulting prediction accuracy might also be compromised. Historical data can be updated with more current data, historical and real-time data can be used as verification mechanisms for one another, etc. If a corresponding mobility digital twin is not available, then a determination regarding whether or not neighboring human or vehicle mobility digital twins are available is made at operations 366 and 376, respectively. It should be understood that neighboring actors may have relevant data or information that can be helpful for a mobility digital twin to use/learn from, make predications, output actuation control instructions, etc. For example, neighboring entities, such as neighboring drivers in their respective neighboring vehicles may experience the same occurrence or event, such as a weather event, traversal of the same section of roadway, etc.

At operations 368 and 378, upon a determination that a neighboring human or vehicle actor are available, real-time as well as historical human and vehicle data are fetched, respectively. The manner in which real-time data may be obtained or fetched in the physical space 110 has been described above. [INVENTOR QUESTION

If neighboring mobility digital twins are not available, or upon fetching real-time/historical data regarding neighboring physical actors, a check is performed to determine if a surrounding traffic mobility digital twin is available at operation 380 akin to determining availability of a digital twin as described above. If no digital twins (neighboring or otherwise) are deemed to be available, as noted above, an assumption is made that no corresponding digital twin exists/a particular digital twin does not desire to receive data. In some embodiments, lack of digital twin availability may prompt construction of a new digital twin corresponding to the physical actor/operation source of the data (or a digital twin(s) willing to be discovered/available to receive such data.

If a surrounding traffic mobility digital twin is available, at operation 382, both real-time and historical data associated with the surrounding traffic can be obtained. That is, real-time data regarding the surrounding traffic and the environment can be obtained from road sensors, traffic signs, weather reports, for example. Historical data can be obtained from the traffic data lake 126a. Upon obtaining the relevant real-time/historical data regarding surrounding traffic conditions/characteristics, one or more microservices can be executed. For example, based on the real-time and historical data, traffic digital twin 126 may execute traffic flow monitoring microservice 126b, generate or alter routing/navigation via routing and navigation microservice 126d, and so on. As noted above, upon execution of such microservices, corresponding actuation control instructions, signals, etc., can be transmitted back to the physical space 110/corresponding physical actor(s)/operation(s) as appropriate. That is, a digital twin microservice can request data from other digital twins as needed/desired, and those digital twins can then share microservice output with the corresponding physical actors/operations.

It should be noted that while FIG. 3C illustrates “parallel” operations between vehicle and human-related data gathering, such operations need not necessarily occur in parallel. For example, a particular mobility digital twin may not be available at the same time another mobility digital twin is available. For example, data/guidance from a certain digital twin can be stored on, e.g., a local machine of the physical actor (i.e., vehicle). When this digital twin is no longer available, its guidance/data will remain active for a certain period (based on the time sensitivity of the microservice), which can be aggregated with the guidance/data from other active digital twins.

FIG. 4 illustrates an example cloud architecture 400 on which MDT system 100 may be implemented. The cloud architecture 400 may be a data-driven platform for both real-time and bulk-batch ingestion, processing, and analytics. As shown in FIG. 4, cloud architecture 400 can be divided into three parts. A first part can comprise a cloud platform 402, while a second part can comprise a virtual private cloud 404 within cloud platform 402. It should be understood that those aspects/components of cloud architecture 400 that reside within cloud platform 402 may correspond to digital space 120 (FIG. 1). Those aspects/components that reside outside of the cloud platform 402 may be considered to correspond to the physical space 110 (FIG. 1).

Cloud platform 402 may comprise the following components: analytics workbench 406, data stores 408, processing component(s) 410, which may be a distributed real-time processing component(s), a rule engine 412, and artificial intelligence (AI)/machine learning (ML) AI/ML MDT microservices 414.

With distributed real-time processing, existing tools such Amazon® Elastic Kubernetes Service (EKS) (is a service that builds, secures, operates, and maintains Kubernetes clusters, Kubernetes being an automated deployment, scaling, and management system for containerized applications), Apache Kafka® (a distributed event streaming platform that can be used for streaming analytics or real-time data feeds), and Apache Storm™ (a real-time distributed computation system) can be leveraged to provide real-time processing and analytics.

Analytics workbench 406 provides big data analytics functionality for analyzing data received from physical actors in physical space 110 or for analyzing historical data, e.g., from one or more digital twin data lakes. Analytics workbench 406 may comprise a distributed, scalable time-series database monitoring system, an example of which is OpenTSDB, which in turn is built atop Apache HBase™ which is an example of a non-relationship distributed database. This supports a writing rate of up to millions of entries per second, supports data storage with millisecond-level precision, and preserves data permanently without sacrificing precision. Such speed and precision data storage is useful in the context of MDT system 100 given the amount of data that can be generated by humans, vehicles, and traffic actors, not to mention communication layer 130's role to communicate between physical space 110 and digital space 120. As noted above, MDT system 100 can be used to generate actuation control signals for directing a vehicle's ADAS or ADS. In addition, Apache Spark™, a distributed processing system, may be used to conduct predictive analytics using a cloud-based big data platform (for large-scale distributed data processing, ML, etc.), such as Amazon EMR clusters.

Rule engine service 412 can be used to evaluate any rules configured for entities/actors (e.g., humans and vehicles) on the data received from an event queue (e.g., Kafka queue), and redirects it to AI/ML Framework & Digital Twin Microservices 414 based on the rule validation result. AI/ML Framework & Digital Twin Microservices 414 are the core of this cloud architecture, where end users are able to implement customized algorithms and applications with various objectives. This component can be used to process time-series data sent from the physical space 110 using statistical techniques, and sends guidance back to the entities in the physical space 110. The data workflow is triggered via Apache Airflow™, a workflow management platform.

Data stores 410 can comprise, for example, a scalable storage infrastructure, an example of which is Amazon S3 to build each of the digital twin data lakes. Moreover, data stores 410 can comprise a database service that is purpose-built for JSON data to execute flexible, low latency queries to obtain a near real-time record of events in parallel on a massive scale, e.g., Amazon DocumentDB. Further still, data stores 410 can include a non-relational database and caching server that is highly replicated, such as Redis.

Outside VPC 404, but nevertheless resident within cloud platform 402, is an IoT core 420 which enables the connection between IoT devices (such as mobile applications, simulators, real vehicles, and remote controlled vehicles) and the cloud without a need to provision or manage servers. In other words, IoT core 420 may be a managed cloud service that allows connected devices to interact with cloud applications or other devices in the cloud. In some embodiments, IoT core 420 may supports various devices and messages, and can process/route those messages to cloud endpoints/devices reliably and securely. A bulk data Ingestion component 424 may also be included as part of cloud platform 402. Bulk data ingestion component 424 enables the ingestion of data (on the order of terabytes) in batch mode into appropriate MDT data lakes. Some scenarios where this component can be triggered are, e.g., at the end of vehicle trip, where bulk data ingestion is used to obtain all or some subset of data collected over some period of time/window. Additionally, bulk data ingestion component 414 may be used for periodic bulk data ingestion, event-triggered data ingestion, or in-vehicle data logging.

An authentication service 428, such as OpenID Connect, may be used as a simple identity layer on top of an authorization protocol, which is adopted to verify the identity of end users based on the authentication performed by an authorization server (not shown), as well as to obtain the basic profile information about end users. An application programming interface (API) gateway 426 may be a cloud-managed service used to create, publish, maintain, monitor, and secure APIs at any scale. The API gateway 426 acts as a “front door” for applications to access data or functionalities from any backend services provided via cloud platform 402.

Outside of cloud platform 402, external data sources can be leveraged to enrich the functionalities of cloud microservices. For example, traffic data 454, map data 452, and weather data 450 may be integrated into API gateway 426 via HTTP. With such data, more microservices can be deployed in, e.g., a traffic digital twin, such as traffic digital twin 126, and hence provide better guidance towards humans and vehicles in the physical space 110, e.g., human actor 112 and vehicle actor 114. Additionally, a web portal 456 is designed to visualize the digital processes on the cloud, and enable end users to create and modify microservices, such as those associated with the various mobility digital twins.

Example data sources are shown in FIG. 4, which stand for the human, vehicle, and traffic actors 112, 114, and 116, respectively in physical space 110 of MDT system 100. Mobile applications 440 are typically designed for both Android and iOS, where end users' position and speed data, for example, (measured by GPS and gyroscope sensors) can be uploaded to IoT Core 420 via MQTT, a publish-subscribe protocol used top transmit messages between devices. Additionally, a customized edge gateway 432 allows external simulators 442 (such as SUMO and Unity), and real vehicles and remote controlled vehicles 446 (with ROS2 embedded) to exchange messages with IoT Core 420 via MQTT.

Systems and methods are provided herein for effectuating a mobility digital twin framework/system that can be implemented in the cloud and have the ability to ingest different types of data, e.g., vehicle-related data, simulations, scaled down vehicles, as opposed to just data from different sources (as is typically the case in conventional digital twin systems). Moreover, with this functionality comes the ability to, when warranted, integrate such data in unique ways, e.g., to substitute simulated/scaled-down versions of data for missing data, bad data, or real word data. Following the example, remote controlled cars can be used as a scaled down alternative to gather relevant data that can be used for scaling decisions, for example. Moreover, data can be aggregates, segregated, or repaired as needed. Thus MDT system 100 has the ability to deal with real world idiosyncrasies without compromising the quality of service end users might otherwise experience, and any compromises on safety due to faulty data.

It should be understood that the components, mechanisms, and the like disclosed herein that make up cloud architecture 400 are non-limiting examples. Those having ordinary skill in the art would know alternative components or mechanisms that could also be used in accordance with embodiments of the disclosed technology.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters

It should be noted that the terms “approximately” and “about” used throughout this disclosure, including the claims, are used to describe and account for small deviations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%

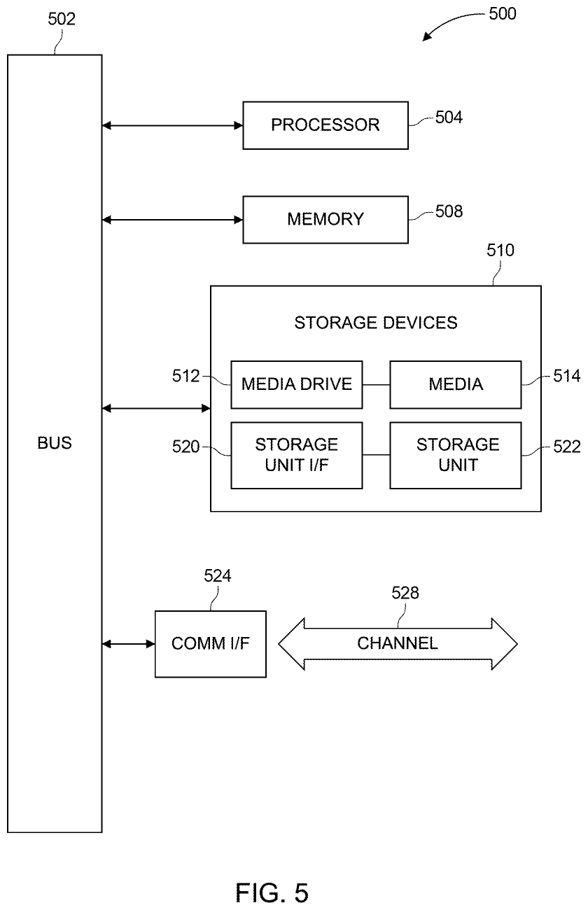

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up the vehicle data gathering circuit 310 or any processing components/elements of FIG. 4, for example. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
gathering data regarding a physical object;
fetching a data schema from a cloud-based digital space comprising a digital twin corresponding to the physical object;
conforming the data to match the data schema;
transmitting the conforming data to the cloud-based digital space;
receiving instructions controlling actuation regarding the physical object from the cloud-based digital space, the instructions having been derived from processing of the conforming data in the cloud-based digital space.

2. The method of claim 1, wherein the physical object comprises at least one of a vehicle, a human, and a traffic device.

3. The method of claim 1, wherein the gathering of the data comprises at least one of obtaining data from one or more monitoring devices associated with the physical object, and receiving data from one or more vehicle-to-anything (V2X) communications regarding the physical object.

4. The method of claim 1, wherein conforming the data to match the data schema comprises pre-processing one or more data fields of the data, the conforming data comprising data remaining after the pre-processing of the one or more data fields of the data to be transmitted to the cloud-based digital space.

5. The method of claim 1, wherein the digital twin comprises a data lake and one or more microservices, the application of which influence operation of the physical object.

6. The method of claim 5, wherein the processing of the conforming data comprises at least one of storing the conforming data in the digital lake, modeling the physical object using the digital twin based on the conforming data, simulating the operation of the physical object using the conforming data, performing machine learning and prediction using the conforming data.

7. The method of claim 5, wherein the data lake further comprises stored historical conforming data related to the digital twin.

8. The method of claim 7, wherein the processing of the conforming data in the cloud-based digital space includes processing of the stored historical conforming data in addition to the stored conforming data received from the physical object.

9. The method of claim 1, further comprising requesting data associated with another digital twin to be sent to the digital twin corresponding to the physical object.

10. The method of claim 1, further comprising determining availability of the digital twin based prior to the transmitting of the conforming data to the cloud-based digital space.

11. The method of claim 10, further comprising, determining availability of a digital twin corresponding to a neighboring physical object, wherein a type of the neighboring physical object is the same type as that of the physical object.

12. The method of claim 11, further comprising obtaining data from the data lake of the digital twin corresponding to the neighboring physical object.

13. The method of claim 12, further comprising processing the obtained data in conjunction with the conforming data regarding the physical object.

14. The method of claim 10, further comprising, determining availability of a digital twin corresponding to one or more other physical objects surrounding at least one of the physical object or the neighboring physical object.

15. The method of claim 13, further comprising obtaining data from the data lake of the digital twin corresponding to the one or more other physical objects surrounding at least one of the physical object or the neighboring physical object.

16. The method of claim 15, further comprising processing the obtained data in conjunction with the conforming data regarding the physical object.

17. A cloud-based system effectuating an end-to-end framework, comprising:
a cloud-based platform hosting one or more digital twins corresponding to one or more physical objects;
a communications layer communicatively connecting the one or more digital twins to the one or more physical objects, wherein:
the communications layer transmits data regarding the one or more physical objects to at least the one or more corresponding digital twins; and
the communications layer transmits instructions that have been derived from processing of the transmitted data by the one or more digital twins to the one or more physical objects to which the one or more digital twins correspond, effectuating performance of one or more operations at or by the one or more physical objects and achieving the end-to-end framework.

18. The cloud-based system of claim 17, wherein the one or more corresponding digital twins comprises a data lake and one or more microservices, the application of which influence operation of the one or more physical objects in achieving the end-to-end framework.

19. The cloud-based system of claim 17, wherein the one or more physical objects comprises at least one of a vehicle, a human, and a traffic device.

20. The cloud-based system of claim 17, wherein the processing of the transmitted data comprises modeling the one or more physical objects using the one or more corresponding digital twins, simulating operation of the one or more physical objects using the transmitted data, performing machine learning and prediction using the transmitted data.
